(19) United States
(12) Patent Application Publication
(10) Pub. No.: US 2008/0050934 A1
(43) Pub. Date: Feb. 28, 2008

(54) Electrical connection for porous material

(75) Inventors: Michael J. Pollard, Peoria, IL (US); Jo L. Costura, Lincolnshire (GB); Matthew T. Kiser, Chillicothe, IL (US); Robert L. Meyer, Metamora, IL (US)

Correspondence Address: Caterpillar Inc.;Intellectual Property Dept., AB 6490, 100 N.E. Adams Street, PEORIA, IL, 61629-6490, US

(73) Assignee: Caterpillar Inc., Peoria, IL (US)

(21) Appl. No.: 11/900,514

(22) Filed: Sep. 12, 2007

Related U.S. Application Data
(63) Continuation-in-part of application No. 11/319,025, filed on Dec. 27, 2005.

(51) Int. Cl. H01R 33/00

(52) U.S. Cl. 439/34

(57) ABSTRACT

An electrical connection element for providing an electrical connection to a porous material may include a first electrically conductive plate disposed on at least a portion of a first side of the porous material. A second electrically conductive plate may be disposed on at least a portion of a second side of the porous material, opposite to the first side. An electrically conductive material may impregnate the porous material in a region between the first and second electrically conductive plates, and an electrical connector may be attached to at least one of the first and second electrically conductive plates.

### CROSS REFERENCE TO RELATED APPLICATIONS

This application is a continuation-in-part application of U.S. patent application Ser. No. 11/319,025, filed on Dec. 27, 2005, the benefit of priority from which is herein claimed, and the disclosures of which are incorporated herein by reference in their entirety.

### TECHNICAL FIELD

The present disclosure is directed to an electrical connection for a porous material and, more particularly, to a method for creating such an electrical connection that is for use with a particulate filter in an exhaust system.

### BACKGROUND

Internal combustion engines, including diesel engines, gasoline engines, natural gas engines, and other engines known in the art, may exhaust a complex mixture of air pollutants. The air pollutants may be composed of gaseous compounds and solid particulate matter, which may include unburned carbon particles called soot.

Due to increased attention on the environment, exhaust emission standards have become more stringent and the amount of particulates emitted from an engine may be regulated depending on the type of engine, size of engine, and/or class of engine. One method that has been implemented by engine manufacturers to comply with the regulation of particulate matter exhausted to the environment has been to remove the particulate matter from the exhaust flow of an engine using a particulate trap. A particulate trap is a filter designed to trap particulate matter in, for example, a mesh filtering media. During operation, the mesh filtering media of the particulate trap may saturate and clog with particulate matter. As a result, an undesirable exhaust system backpressure may develop.

To minimize or prevent exhaust system backpressure, the particulate trap may be subjected to a regeneration process in which some, most, or all of the trapped particulate matter may be removed from the filter. In one regeneration technique, an electric current may be passed through the mesh filtering media, which may include a metal, for example. In response to this current, the temperature of the filter may rise due to resistive heating. Ultimately, the temperature may be raised above the combustion temperature of the trapped particulate matter, and the particulate matter may be burned away from the filter.

Establishing a suitable electrical connection to the mesh of the particulate trap can be challenging. Particularly, the joint between the filter media and an electrical connector, which provides the current for regeneration, may be exposed to a harsh environment within the exhaust system. In this environment, the high temperatures and presence of corrosive compounds in the exhaust stream can promote corrosion and oxidation of the joint. Further, oxidation at the joint may even be facilitated by the porous nature of the filter media.

Oxidation of the joint and the surrounding mesh filter media can lead to the development of various oxide materials at the joint that can cause an increase in electrical resistance at the joint. As a result of the higher electrical resistance, there may be a disproportionate amount of localized heating occurring in the area of the joint. The mesh filter material can melt, which can further increase the resistance at the joint. Ultimately, an open circuit condition may result, which would prevent the flow of current to the filter media and, therefore, eliminate the capability of regeneration of the filter media through resistive heating. Thus, there is a need for an electrical connection to the filter of a particulate trap that can withstand the harsh environment within an exhaust system.

At least one method for forming a joint with a mesh filter media is disclosed in U.S. Patent Application Publication No. US 2004/0031748 (“the 748 patent publication”) to Kochert et al. The '748 patent publication describes a process of forming a joint between a filter medium and a supporting structure by welding the filter medium to the supporting structure.

Although the joint described in the '748 patent publication may be suitable for use in certain exhaust system applications, this type of joint may have several shortcomings. For example, the welding technique may require temperatures high enough to damage the mesh material. Melting of the mesh during the welding process may have the effect of severing conductive elements of the mesh, which could lead to increased electrical resistance at the joint. Thus, the welding process of the '748 patent publication may be unsuitable for forming an electrical connection to a filter media.

The present disclosure is directed to overcoming one or more of the problems of the prior art steam oxidation technique.

### SUMMARY OF THE INVENTION

One aspect of the present disclosure includes method of providing an electrical connection to a porous material that includes packing at least a portion of the porous material with an electrically conductive powder, attaching an electrical connector to the at least a portion of the porous material, and sintering the electrically conductive powder to form a sintered electrically conductive material that bonds to the electrical connector and the at least a portion of the porous material.

Another aspect of the present disclosure includes a method of providing an electrical connection to a porous material that includes disposing a brazing element on at least a portion of the porous material, disposing the at least a portion of the porous material and the brazing element between a first conductive plate and a second conductive plate, compressing the at least a portion of the porous material and the brazing element between the first and second conductive plates, attaching an electrical connector to at least one of the first and second conductive plates, and melting the brazing element such that at least some of the brazing element impregnates the porous material.

Another aspect of the disclosure relates to a method of providing an electrical connection to a porous material. The method includes placing at least a portion of the porous material into an electrically conductive compressive fixture, flowing a molten, electrically conductive material into the at least a portion of the porous material such that the molten material contacts the compressive fixture, allowing the electrically conductive material to harden, and attaching an electrical connector to the compressive fixture.

### BRIEF DESCRIPTION OF THE DRAWINGS

FIG. 1 is a schematic illustration of an exemplary exhaust system according to a disclosed embodiment.

FIG. 2 is a schematic, partial cross-sectional view of an electrical connection element according to an exemplary disclosed embodiment.

FIG. 3 is a schematic illustration of a conductive plate according to an exemplary disclosed embodiment.

FIG. 4 is a schematic, partially exploded view of components of an exemplary electrical connection element.

FIG. 5 is a schematic, partially exploded view of components of an exemplary electrical connection element.

FIG. 6 is a schematic, partially exploded view of components of an exemplary electrical connection element.

### DETAILED DESCRIPTION

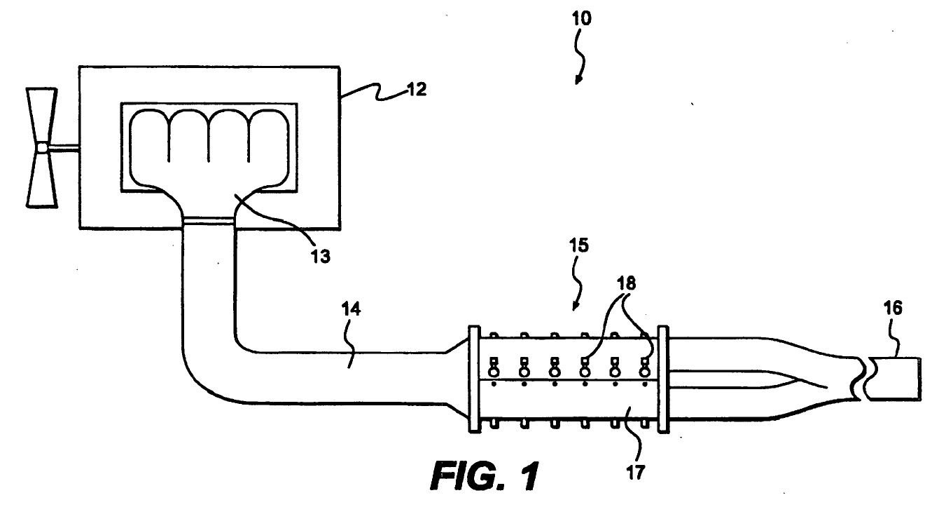

FIG. 1 provides a schematic representation of an exhaust system 10. The exhaust system 10 may include a power source 12, an exhaust manifold 13, an exhaust conduit 14, a particulate trap 15, and an exhaust outlet 16. The power source 12 may be any source of power that generates an exhaust stream and may include a diesel engine, gasoline engine, natural gas engine, and any other engine known in the art. Exhaust from the power source 12 may be expelled through the exhaust manifold 13 and carried by the exhaust conduit 14. Particulate matter that might be present in the exhaust stream can be filtered out of the exhaust stream by any filtering media that is present within the particulate trap 15. The filtered exhaust exits the particulate trap 15 and flows out of the exhaust system 10 through the exhaust outlet 16.

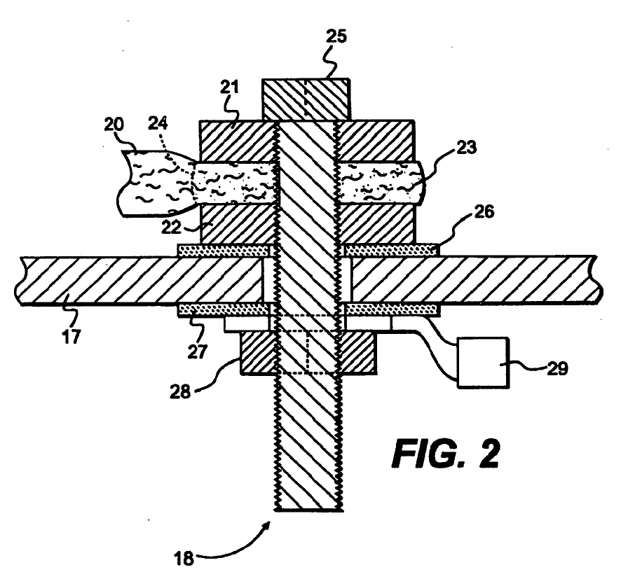

The particulate trap 15 may be configured in a variety of ways. In one embodiment, the particulate trap 15 includes a housing 17 and a porous material disposed within the housing 17. In one embodiment, the porous material includes a mesh filtering media 20 (FIG. 2) disposed within the housing 17 for filtering particulate matter from an exhaust stream. The filtering media 20 may include any structure suitable for capturing particulate matter and may include any material suitable for enduring exposure to the environment within exhaust system 10. In one embodiment, the filtering media 20 includes a porous mat. In another embodiment, the filtering media 20 may include a wire mesh arranged in a layered structure where each layer may offer a different mesh density. The filtering media 20 may include at least one of an oxidation resistant metal-based material, a ceramic material, an iron-based material, stainless steel, or any other suitable material known in the art.

To facilitate regeneration of the filtering media 20, the particulate trap 17 may include one or more electrical connection elements 18 that extend through the housing 17 and provide a means for establishing an electrical connection between the filtering media 20 and a source of electrical current (not shown) located external to the particulate filter 15. While in certain applications, a single electrical connection element 18 may be sufficient for supplying regeneration current to the filtering media 20, the particulate trap 15 may include a plurality of connection elements 18 to distribute the regeneration current over the filtering media 20.

FIG. 2 provides a schematic, partial cross-sectional view of a single electrical connection element 18. The electrical connection element 18 may include a first electrically conductive plate 21 and a second electrically conductive plate 22. These plates may be configured to contact and compress a portion of the filtering media 20, as shown in FIG. 2. The plates 21 and 22 may be made from any suitable material for establishing an electrical connection with the filtering media 20. The plates 21 and 22 may include stainless steel. The plates 21 and 22 may also be configured in a bus bar arrangement, such that the plates 21 and 22 form part of a plurality of connection elements 18 in the particulate trap 15.

The electrical connection element 18 may include an electrically conductive material 23 disposed in the filtering media 20. The electrically conductive material 23 may impregnate at least some, and possibly all, of the pores of the filtering media 20 in a region between the first and second electrically conductive plates 21 and 22. Particularly, the region between the plates 21 and 22 impregnated by the electrically conductive material 23 may constitute less than, equal to, or more than the total volume contained between the plates 21 and 22. Further, an impregnation boundary 24 may be present in the filtering media 20. Beyond the boundary 24, little or none of the electrically conductive material 23 may be included in the filtering media 20. The location of the boundary 24 may vary according to a particular application. In one embodiment, however, the boundary 24 may be located near an edge of either or both of the electrically conductive plates 21 and 22.

The electrically conductive material 23 may include any material suitable for establishing an electrical connection between plates 21 and 22 and the filtering media 20. The electrically conductive material 23 may also include constituents that demonstrate at least some resistance to the corrosive environment that may be present within the exhaust system 10. In one embodiment, the electrically conductive material 23 may include nickel. Particularly, the electrically conductive material 23 may include a BNi-5a nickel compound. Other compounds including aluminum, silver, stainless steel, iron, copper, and any other conductive material may also be appropriate in certain applications.

The electrically conductive material 23 may include a brazed material provided, for example, by using a brazing preform material, melting the preform, and allowing the brazing material to flow into the filtering media 20. The electrically conductive material 23 may also include a sintered material formed by heating a powder material packed within the filtering media 20. These processes will be discussed in detail below.

The electrical connection element 18 may also include an electrical connector 25 attached to at least one of the electrically conductive plates 21 and 22. In one embodiment, the electrical connector 25 may include a threaded fastener configured to engage threads on at least one of the conductive plates 21 and 22. For example, the electrical connector 25 may include a bolt. The electrical connector 25 may extend through the conductive plate 21, the filtering media 20, and the conductive plate 22. Using threads included on at least one of the conductive plates 21 and 22, the electrical connector 25 may be used to hold the conductive plate 21, the region of filtering media 20 between the conductive plates 21 and 22, and the conductive plate 22 in compression. By compressing the filtering media 20 in this region, the amount of porosity within filtering media 20 in this region may be reduced.

The electrical connector 25 may be configured to extend beyond the conductive plate 22. In one embodiment, the electrical connector 25 may extend through the housing 17 of the particulate trap 15. In this way, the electrical connector 25 may be used as a means for supplying regeneration current to the filtering media 20 from a current source (not shown) external to the particulate trap 15. In this embodiment, the electrical separators 26 and 27 may be included to electrically isolate the electrical connector 25 and the conductive plate 22 from the housing 17. The electrical separators 26 and 27 may include any suitable electrically insulating material. In one embodiment, the electrical separators 26 and 27 may include ceramic washers. A nut 28 may be included in the electrical connection element 18 for securing the electrical connector 25, the conductive plates 21 and 22, the filtering media 20, and the electrical separators 26 and 27 to the housing 17. Additionally, the electrical connection element 18 may include a terminal 29 attached to the electrical connector 25. The terminal 29 may include any suitable structure for receiving and attaching to a conductor of electric current (e.g., a wire). In one embodiment, the terminal 29 may include a soldering terminal.

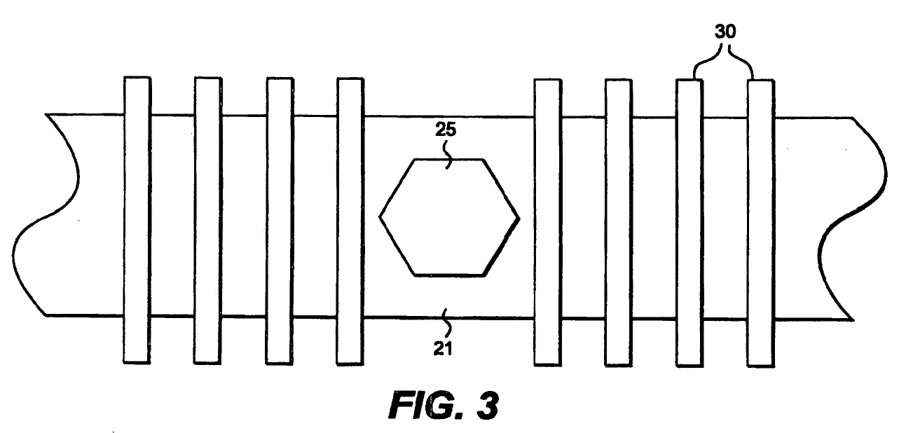

FIG. 3 provides a schematic illustration of an embodiment in which the conductive plate 21 includes structure to promote heat transfer away from the region of the filtering media 20 included between the conductive plate 21 and the conductive plate 22. Specifically, the conductive plate 21 may include cooling structures, such as cooling fins 30. It should be noted that either or both of the conductive plates 21 and 22, or any other appropriate structure in the electrical connection element 18, may include similar structures for promoting the transfer of heat away from the electrical connection element 18.

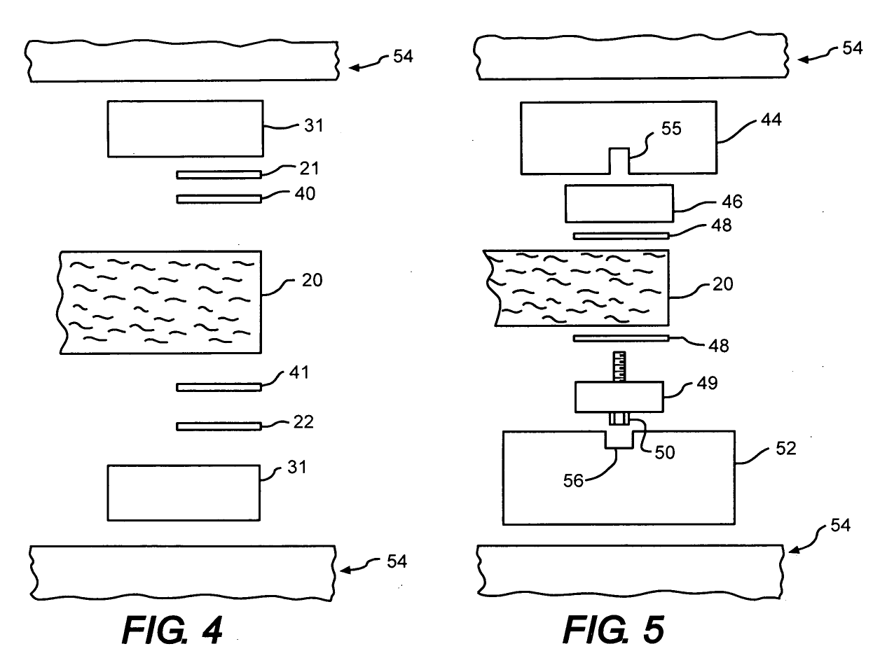

Methods for establishing an electrical connection to the filtering media 20 will now be described. In the embodiment shown in FIG. 4, the elements used in a process for establishing the electrical connection to the filtering media 20 include a brazing element preform 40, such as a brazing wire, paste, or foil, may be disposed on at least a portion of the filtering media 20. As shown in FIG. 4, the brazing preform 40 is placed between the filtering media 20 and the conductive plate 21. Another brazing preform 41 may be placed between the filtering media 20 and the conductive plate 22. The brazing preforms 40, 41 may comprise any suitable electrically conductive material. For example, the brazing preforms 40, 41 may include nickel.

Once the brazing preforms 40, 41 have been located at desired positions on the filtering media 20, the brazing preforms and a portion of the filtering media 20 may be compressed between the conductive plates 21 and 22. According to the present disclosure, the compression between the conductive plates 20, 21 would be under a substantially consistent or constant load, as is described in greater below, during the process to form the joint. The benefit of applying a substantially consistent load during the process is to maintain a strong connection between the elements of the joint during the creation of the joint. As one skilled in the art can appreciate, there can be a change in thickness, or other dimensions, as the joint fuses and forms. This could lead to a relaxation of the load on the joint and a reduction of joint density. This could then lead to an increase in the resistance of the electrical connection and resultant heat generation. The consistent application of a load, therefore, accounts for and accommodates any such changes that might occur by continuing to hold the elements tightly together. This process allows for the creating of a better joint between the conductive plates 20, 21, the brazing preforms 40, 41, and the filtering media 20. An electrical connector (not shown) may be attached to at least one of the conductive plates 21 and 22 during this process.

It should be appreciated that any suitable mechanism can be used to maintain the consistent load upon the joint during the creation of the electrical connection. For example, a press, shown schematically at 54 in FIG. 4 could be used to maintain the consistent load during the formation of the joint. With the use of the press 54, or a similar mechanism, the mesh filtering media 20 can be kept compressed as the braze or filler material infiltrates filtering media 20. Once the brazing materials solidify upon cooling, the porous filtering media 20 would be held in a compressed, dense, filled state, that can significantly improving electrical conduction. Such a process can be referred to as a liquid phase process. Additionally, it can be appreciated that the implementation of special tooling 31 may be necessary to accommodate the press 54 or other elements during this process. The special tooling 31 is shown schematically in FIG. 4 and can represent any intermediate apparatuses, components, or elements required to perform the methods described and shown herein. In particular, the tooling 31 may comprise pins or other features to ensure proper alignment between the other elements shown in the Figures, or can be used as a protective mechanism relative to the press 54 or other components.

In order to provide electrically conductive material 23 between the conductive plates 21 and 22, the brazing elements may be heated and melted. As a result, the melted brazing material may flow into and impregnate pores within the filtering media 20. Upon hardening, the electrically conductive material 23 may contact and bond together the conductive plate 21, the filtering media 20, the conductive plate 22, and the connector.

It can be appreciated that sintering may also be used to form the electrically conductive material 23. For example, in the region between the conductive plates 21 and 22, the filtering media 20 may be packed with an electrically conductive powder. This powder may include at least one of nickel, aluminum, copper, iron, tungsten, silicon carbide, cobalt, and titanium. For purposes of this application, the phrase “at least one of” followed by a list of materials is intended to mean that the electrically conductive material may include: only a single selected member from the list of materials, two or more selected members from the list of materials, or all of the members of the list of materials. The powder-packed filtering media may be compressed between the conductive plates 21 and 22.

It should be appreciated that the application of a substantially consistent or constant load during this process would be used to form an electrical connection with reduced electrical resistance. The application of the consistent load, or controlled pressure, assists with the compaction of the powder and to increase the impetus for sintering, which accomplishes the purpose of reducing porosity, and thereby decreasing electrical resistance.

The electrically conductive material 23 may also be formed by flowing a molten material, such as a metal, into a portion of the filtering media 20. The filtering media 20 may be placed into an electrically conductive compressive fixture, which may include, for example, the conductive plate 21, the conductive plate 22, and/or the electrical connector 25. The molten material may be flowed into the filtering media 20 by dipping the filtering media 20 into a reservoir of molten material, by pouring molten material into the filtering media 20, or by any other appropriate method for introducing molten material into the filtering media 20. The molten material may include at least one of nickel, aluminum, copper, iron, tungsten, titanium or any other suitable, electrically conductive material. Allowing the introduced molten material to harden may form the electrically conductive material 23.

An electrical connector may be attached to the compressive fixture before or after forming the electrically conductive material 23. Upon hardening, the molten material may form electrically conductive material 23, which may form a solid joint between the conductive plates 21 and 22, the filtering media 20, and the electrical connector.

It should be appreciated that the application of a consistent load during any of the methods described above is used to create an electrical connection having reduced electrical resistance compared to other known methods. In addition, the electrical connector 25 is shown without a bolt or other fastener integrated into the connector. It should be appreciated that the connector can be pre-drilled or post-drilled to allow a bolt to be passed through the connector to facilitate a connection to a separate piece of equipment, such as a particulate filter.

The elements used in an alternate embodiment of a method for establishing the electrical connection to the filtering media 20 are shown in FIG. 5. In this embodiment, an electrical connector 50 is used to facilitate the electrical connection to the conductive plate 49. Although two conductive plates 46, 49 are shown in FIG. 5, it should be appreciated that only one electrical connector 50 can be used and could extend through the conductive plate 49 (as shown), a brazing element preform 48, and filtering media 20 during the forming process. It should be appreciated that an electrical connector could be implemented in any suitable position.

In the embodiment shown in FIG. 5, the elements used in the process for establishing the electrical connection to the filtering media 20 include a brazing element preform 48, such as a brazing wire, paste, or foil, may be disposed on at least a portion of the filtering media 20. As shown in FIG. 5, the brazing preform 48 is placed between the filtering media 20 and the conductive plates 46. Another brazing preform 48 may be placed between the filtering media 20 and the conductive plate 49. The brazing preforms 48 may comprise any suitable electrically conductive material. For example, the brazing preforms 48 may include nickel.

As introduced above, an electrical connector 50 is used to facilitate an electrical connection to adjacent conductive plates 46, 49. The electrical connector 50 may include any structure for facilitating an electrical connection to the conductive plates 46 or 49 (e.g., a soldering terminal, a soldering post, a mechanical terminal, or any other connection device known in the art), in the illustrated embodiment, the electrical connector 50 generally corresponds in structure and operation to the electrical connector 25 shown in FIG. 3. The electrical connector 50, which may include a bolt, may enable compression of the filtering media 20 and the conductive plates 46, 49 (e.g., by tightening the electrical connector 50 using threads disposed in conductive plates 46, 49) and also provide a suitable means for establishing an electrical connection to the conductive plates 46, 49. It should be noted that the steps of compressing the filtering media 20 and attaching an electrical connector to at least one of the conductive plates 46, 49 may not be required for all applications and may be performed in any order.

As shown in FIG. 5, dedicated tooling elements 44 and 52 are used to accommodate the electrical connector 50. In particular, tooling element 52 includes a recess 56 configured to accommodate a “head” portion of the electrical connector 50 and tooling element 44 includes a recess 55 configured to accommodate a “shank” portion of the electrical connector. Depending on the length of the connector 50 and the thickness of the other components, the recess 55 in the tooling element 44 can be optional. It can be appreciated that if the electrical connector 50 were positioned such that the head portion of the connector 50 is adjacent the conductive plate 46, the dedicated tooling element 44 would be adapted to accommodate the head of the connector 50 and the tooling element 52 would be adapted to accommodate the shank of the connector 50. It should be appreciated that multiple electrical connectors 50 could also be used, with corresponding dedicated tooling elements having corresponding recesses 55, 56, if it were so desired.

As was described above, formation of the joint and compression between the conductive plates 46 and 49 could be under a consistent load. It should be appreciated that any suitable mechanism can be used to maintain the consistent load upon the joint during the creation of the electrical connection. For example, a press or dead weight, shown schematically at 54 in FIG. 5 could be used to maintain the consistent load during the formation of the joint. With the use of the press 54, or a similar mechanism, the mesh filtering media 20 can be kept compressed as the braze or filler material infiltrates filtering media 20. Once the brazing materials solidify upon cooling, the porous filtering media 20 would be held in a compressed, dense, filled state, that can significantly improving electrical conduction. Such a process can be referred to as a liquid phase process.

Additionally, using the processes described above with respect to FIG. 4, an electrically conductive powder may be heated and sintered to form the electrically conductive material 23 that bonds to the electrical connector 48, 50 and at least a portion of the filtering media 20. It should be appreciated that the electrical joint can be formed using other mechanisms, while maintaining the application of the consistent load during the process, as was described above.

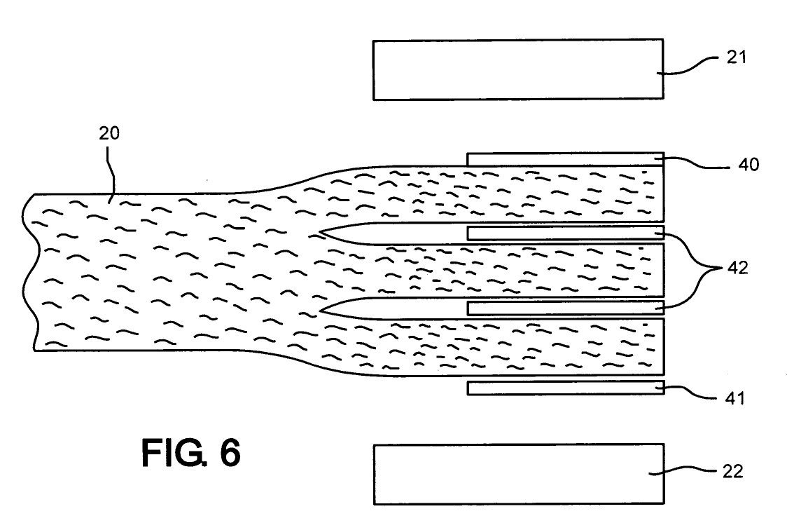

The elements used in an alternate embodiment for a method for establishing the electrical connection to the filtering media 20 are shown in FIG. 6. According to this embodiment, a brazing element preform, such as a brazing wire, paste, or foil, may be disposed on at least a portion of the filtering media 20. For example, as shown in FIG. 6, a brazing preform 40 may be placed between the filtering media 20 and the conductive plate 21. Another brazing preform 41 may be placed between the filtering media 20 and the conductive plate 22. In an embodiment where the filtering media 20 includes a layered structure, one or more brazing preforms 42 may be placed between the various layers of the filtering media 20. The brazing preforms 40, 41, and 42 may comprise any suitable electrically conductive material. For example, the brazing preforms 40, 41, and 42 may include nickel.

Once the brazing preforms 40, 41, and/or 42 have been located at desired positions on the filtering media 20, the brazing preforms and a portion of the filtering media 20 may be compressed between the conductive plates 21 and 22. An electrical connector may be attached to at least one of the conductive plates 21 and 22. While the electrical connector described may include any structure for facilitating an electrical connection to the conductive plate 21 or 22 (e.g., a soldering terminal, a soldering post, a mechanical terminal, or any other connection device known in the art), in one embodiment, the electrical connector may correspond to the electrical connector 25 shown in FIG. 3. The electrical connector 25, which may include a bolt, may enable compression of the filtering media 20 and the conductive plates 21 and 22 (e.g., by tightening electrical connector 25 using threads disposed in conductive plate 22) and also provide a suitable means for establishing an electrical connection to the conductive plate 21 and/or 22. It should be noted that the steps of compressing the filtering media 20 and attaching an electrical connector to at least one of the conductive plates 21 and 22 may not be required for all applications and may be performed in any order. It should be appreciated that the use of a compressive press, dead weights or similar mechanism can also be used to provide a substantially constant load, such as was shown and described above.

To provide electrically conductive material 23 between the conductive plates 21 and 22, the brazing elements may be heated and melted. As a result, the melted brazing material may flow into and impregnate pores within the filtering media 20. Upon hardening, the electrically conductive material 23 may contact and bond together the conductive plate 21, the filtering media 20, the conductive plate 22, and the connector 25.

The electrically conductive material 23 may also be formed by sintering. For example, in the region between the conductive plates 21 and 22, the filtering media 20 may be packed with an electrically conductive powder. This powder may include at least one of nickel, aluminum, copper, iron, tungsten, silicon carbide, cobalt, and titanium. For purposes of this application, the phrase “at least one of” followed by a list of materials is intended to mean that the electrically conductive material may include: only a single selected member from the list of materials, two or more selected members from the list of materials, or all of the members of the list of materials. The powder-packed filtering media may be compressed between the conductive plates 21 and 22. In one embodiment, the electrical connector 25 may be used to contact the conductive plate 21 and/or 22 and may also be used to compress the filtering media 20 by, for example, tightening the electrical connector 25 into threads in at least one of the conductive plates 21 and 22. The electrically conductive powder may be heated and sintered to form the electrically conductive material 23 that bonds to the electrical connector 25 and at least a portion of the filtering media 20.

The electrically conductive material 23 may also be formed by flowing a molten material, such as a metal, into a portion of the filtering media 20. The filtering media 20 may be placed into an electrically conductive compressive fixture, which may include, for example, the conductive plate 21, the conductive plate 22, and/or the electrical connector 25. The molten material may be flowed into the filtering media 20 by dipping the filtering media 20 into a reservoir of molten material, by pouring molten material into the filtering media 20, or by any other appropriate method for introducing molten material into the filtering media 20. The molten material may include at least one of nickel, aluminum, copper, iron, tungsten, titanium or any other suitable, electrically conductive material. The electrically conductive material 23 may be formed by allowing the introduced molten material to harden.

An electrical connector may be attached to the compressive fixture before or after forming the electrically conductive material 23. In one embodiment, the electrical connector 25 in the form of a bolt may be attached to the conductive plates 21 and 22 prior to forming the electrically conductive material 23. Upon hardening, the molten material may form electrically conductive material 23, which may form a solid joint between the conductive plates 21 and 22, the filtering media 20, and the electrical connector 25.

### INDUSTRIAL APPLICABILITY

The disclosed electrical connection may be used in any application that may benefit from an electrical connection to a porous material. The electrical connection may be used, for example, in applications that may be exposed to harsh operating conditions. The use of nickel and/or other corrosion and oxidation resistant materials in the electrical connection may provide corrosion and oxidation resistance to the electrical connection even when exposed to the corrosive, high temperature environment of exhaust system 10. Also, a reduction in porosity of the porous material (e.g., a filtering mesh media or any other porous material) in a region associated with the electrical connection may further increase the resistance of the electrical connection to corrosion and oxidation. This porosity may be reduced by compressing the porous material and/or by impregnating the porous material with electrically conductive material 23.

The techniques used to form the disclosed electrical connection may help preserve the structural integrity of the porous material. Particularly, unlike welding, which may include high processing temperatures and can damage the porous material, the disclosed processes for impregnating filtering media 20 with electrically conductive material 23 (e.g., brazing, sintering, and flowing molten material) may result in less damage to filtering media 20. Less damage to the electrically conductive elements of filtering media 20 may promote uniform resistivity values over filtering media 20. As a result, filtering media 20 may be uniformly heated during a regeneration event. Further, disproportionate heating of the region around the electrical connection to filtering media 20 may be minimized or avoided.

Additionally, as was described above in reference to FIGS. 4-6, the application of a consistent load during the process of forming the electrical connection is used. This results in the mesh or porous filtering media 20 to be kept compressed as the braze or filler material infiltrates the filtering media. Once the filler material solidifies upon cooling, the porous filtering media 20 is held in a compressed, dense, filled state. This improves electrical conduction within the formed connection element.

It will be apparent to those skilled in the art that various modifications and variations can be made in the disclosed electrical connection element without departing from the scope of the disclosure. Additionally, other embodiments of the disclosed electrical connection element will be apparent to those skilled in the art from consideration of the specification. It is intended that the specification and examples be considered as exemplary only, with a true scope of the disclosure being indicated by the following claims and their equivalents.

What is claimed is:

1. A method of providing an electrical connection to a porous material, comprising:
packing at least a portion of the porous material with an electrically conductive powder;
attaching an electrical connector to the at least a portion of the porous material; and
sintering the electrically conductive powder to form a sintered electrically conductive material that bonds to the electrical connector and the at least a portion of the porous material.

2. The method of claim 1, wherein the electrically conductive powder includes at least one of nickel, aluminum, copper, iron, tungsten, silicon carbide, cobalt, and titanium.

3. The method of claim 1, further including compressing the at least a portion of the porous material between conductive plates.

4. The method of claim 3, wherein the connector includes a bolt disposed through the conductive plates.

5. The method defined in claim 3, further including compressing the at least a portion of the porous material and the conductive plates under a substantially consistent load.

6. The method of claim 1, wherein the porous material includes a mesh filter for an exhaust system particulate trap.

7. A method of providing an electrical connection to a porous material, comprising:
disposing a brazing element on at least a portion of the porous material;
disposing the at least a portion of the porous material and the brazing element between a first conductive plate and a second conductive plate;
compressing the at least a portion of the porous material and the brazing element between the first and second conductive plates;
attaching an electrical connector to at least one of the first and second conductive plates; and
melting the brazing element such that at least some of the brazing element impregnates the porous material.

8. The method of claim 7, wherein the porous material includes a mesh filter for an exhaust system particulate trap.

9. The method of claim 7, wherein the brazing element includes at least one of brazing foil, brazing wire, and brazing paste.

10. The method of claim 7, wherein the brazing element includes nickel.

11. The method of claim 7, wherein the brazing element includes a first layer of brazing material disposed between the at least a portion of the porous material and the first conductive plate and a second layer of brazing material disposed between the at least a portion of the porous material and the second conductive plate.

12. The method of claim 7, further including compressing the brazing element, the porous material, the first conductive plate, and the second conductive plate under a substantially consistent load.

13. The method of claim 7, wherein the porous material has a layered structure; and
wherein the brazing element includes one or more additional layers of brazing material disposed between layers of the porous material.

14. The method of claim 7, further including disposing another brazing element between the electrical connector and the at least one of the first and second conductive plates.

15. The method of claim 7, wherein the electrical connector includes a bolt extending through the first conductive plate, the porous material, and the second conductive plate; and
wherein compressing the at least a portion of the porous material and the brazing element between the first and second conductive plates further includes tightening the bolt.

16. The method of claim 15, wherein the electrical connector includes a bolt extending through the first conductive plate, the porous material, and the second conductive plate; and
wherein compressing the at least a portion of the porous material and the brazing element between the first and second conductive plates further includes compressing the bolt, the first conductive plate, the porous material, and the second conductive plate under a substantially consistent load.

17. A method of providing an electrical connection to a porous material, comprising:
placing at least a portion of the porous material into an electrically conductive compressive fixture;
flowing a molten, electrically conductive material into the at least a portion of the porous material such that the molten material contacts the compressive fixture;
allowing the electrically conductive material to harden; and
attaching an electrical connector to the compressive fixture.

18. The method of claim 17, wherein the electrical connector includes a bolt that penetrates the compressive fixture and the at least a portion of the porous material.

19. The method of claim 17, wherein the compressive fixture includes a first electrically conductive plate disposed on a first side of the at least a portion of the porous material and a second electrically conductive plate disposed on a second side of the at least a portion of the porous material opposite the first side.

20. The method of claim 20, further includes compressing the compressive fixture under a substantially consistent load.
